(19) United States
(12) Patent Application Publication
(10) Pub. No.: US 2008/0217582 A1
(43) Pub. Date: Sep. 11, 2008

(54) CLASS OF LUMINESCENT IRIDIUM(III) COMPLEXES WITH 2-(DIPHENYLPHOSPHINO)PHENOLATE LIGAND AND ORGANIC ELECTROLUMINESCENT DEVICE THEREOF

(76) Inventors: Yun Chi, Hsinchu (TW); Pi-Tai Chou, Taipei (TW); Yi-Hwa Song, Taichung (TW); Yuan-Chieh Chiu, Longtan Township (TW); Chiung-Fang Chang, Huwei Township (TW)

Correspondence Address: RABIN & Berdo, PC, 1101 14TH STREET, NW, SUITE 500, WASHINGTON, DC, 20005, US

(21) Appl. No.: 11/683,547

(22) Filed: Mar. 8, 2007

(51) Int. Cl. C07F 15/00; C09K 11/06

(52) U.S. Cl. 252/301.18; 544/225; 546/6

(57) ABSTRACT

A new class of luminescent iridium(III) complexes, luminescent material and organic electroluminescent device thereof had been disclosed. The novel luminescent iridium(III) complexes comprises the formula [(ĈN)₂Ir(P̂O)] with 2-(diphenylphosphino)phenolate as the ancillary chelate. The iridium complexes of the present invention can be used as the red, blue or green-emitting dopants. These luminescent materials can be applied in the fabrication of light-emitting layer of organic electroluminescent devices and providing the high efficiently red, blue or green light organic electroluminescent devices of commercial pursuits.

### BACKGROUND OF THE INVENTION

1. Field of the Invention

The present invention relates to the organometallic complexes, and more particularly to a class of luminescent iridium(III) complexes with 2-(diphenylphosphino)phenolate ligand and organic electroluminescent device thereof.

2. Description of Related Art

Organometallic complexes possessing a third-row transition-metal element are crucial for the fabrication of highly efficient organic light emitting diodes (OLEDs). The strong spin-orbit coupling induced by a heavy metal ion such as iridium (III) promotes an efficient intersystem crossing from the singlet to the triplet excited state manifold, which then facilitates strong electroluminescence by the harnessing of both singlet and triplet excitons induced by charge recombination. Because internal phosphorescence quantum efficiency (ηᵢₙₜ) of as high as ˜100% could be achieved, these heavy metal containing emitters would be superior to their fluorescent counterparts in future OLED applications. As a result, there is a continuous trend of shifting research endeavors to these heavy transition-metal complexes. Moreover, since the manufacture of a full color display requires the usage of emitters with all three primary colors, i.e. RGB color, rationally tuning the emission wavelength of heavy transition-metal phosphorescent emitters over the entire visible range are also represent an important forthcoming research task.

In fact, the tri-substituted (or homoleptic) Ir(III) complexes with formula [Ir(ĈN)₃], (ĈN)H=2-(4′,6′-difluorophenyl)pyridine, 2-phenyl pyridine and 1-phenyl isoquinoline, have shown the anticipated, blue, green and red phosphorescence in both fluid and solid states and, thus, they are highly desirable for fabrication of the phosphorescent OLEDs. Unfortunately, many of the related cyclometalating ligands (ĈN)H do not react with iridium (III) reagents to give the homoleptic iridium (III) complexes by the reported synthetic methods. As a result, researchers developed a distinctive class of iridium complexes with the formula [Ir(ĈN)₂(L̂X)]. However, with respect to the chemical stabilities of these heteroleptic complexes, most of the L̂X ligand belong to the so-called weak field ligands, as they possess the O-donor or N-donor fragments. As the result, the chemical stabilities as well as the relatively energy gap for the metal centered dd transition could not be as strong as those involving the higher field-strength ligands. This case is particular true for the heteroleptic complexes [(ĈN)₂Ir(L̂X)] with L̂X being acetylacetonate, for which lowered thermal stabilities and poor chemical resistance to the acidic media were reported, making the corresponding as-prepared OLED devices suffered from a situation involving the reduced device lifetime and with other inferior characteristics.

### SUMMARY OF THE INVENTION

Accordingly, the present invention is directed to a new class of luminescent iridium(III) complexes with at least one 2-(diphenylphosphino)phenolate as the ancillary chelate for high efficient phosphorescence.

And, the present invention is directed to the luminescent material of the novel luminescent iridium(III) complexes, which can be used as the red, blue or green-emitting dopants.

Besides, the present invention is directed to the organic electroluminescent device of the new class luminescent iridium(III) complexes for providing the high efficiently red, blue or green light organic electroluminescent devices of commercial pursuits.

The present invention provides a new class of luminescent iridium(III) complexes, luminescent material and organic electroluminescent device thereof which comprises a formula [(ĈN)₂Ir(P̂O)], for example, having the following structure:

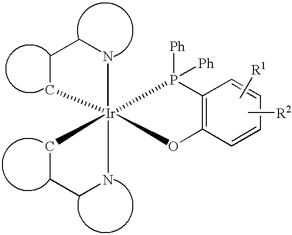

Moreover, a synthesis of the iridium (III) complexes with the formula [(ĈN)₂Ir(P̂O)] comprises the following procedures, see reaction scheme (I):

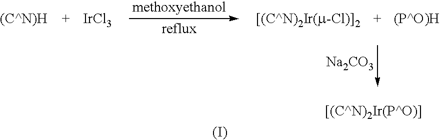

wherein the (ĈN)H is a substituted cyclometalated ligand with structure indicated below:

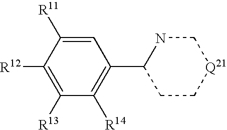

for which, R¹¹, R¹², R¹³ and R¹⁴ represent a hydrogen atom, both saturated and unsaturated alkyl, aryl group, fluorine atom, fluorinated alkyl substituent or other electron-withdrawing substituent, while Q²¹ represents an atomic group forming a nitrogen-containing heterocyclic ring. And, the (P̂O)H is 2-(diphenylphosphino)phenol or its alkyl, aryl, fluoro or CF₃ substituted derivatives and comprises the following structure:

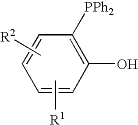

As all six of coordination sites on Ir(III) metal center are occupied by these ĈN and P̂O chelates, the resulting complexes become charge-neutral and sublimable, which are essentially for the subsequent fabrication of OLEDs employing direct thermal evaporation.

The present invention is a new class of luminescent iridium(III) complexes having high efficient phosphorescence and provides a synthetic method thereof.

Since the luminescent iridium(III) complexes of the present invention possess 2-(diphenylphosphino)phenolate as the ancillary chelate, the energies of ππ* or MLCT manifolds, i.e. the energy gap between the ground and the emitting excited states, can be fine-tuned by addition of at least one alkyl, aryl group, or at least one electronegative fluorine atom or even the CF₃ substituent at the phenolate fragment, giving emitters with higher volatility as well as both modified electrochemical and emission characteristics.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a structure of an organic electroluminescent device according to one of the preferred embodiments of the present invention.

FIG. 2 depicts emission spectra of Ir(III) complexes [(dfppy)₂Ir(dppp)], [(dfppy)₂Ir(4Tdppp)], [(dfppy)₂Ir(6Tdppp)] and [(dfppy)₂Ir(4Fdppp)] in CH₂Cl₂ at RT.

FIG. 3 depict emission spectra of Ir(III) complexes [(ppy)₂Ir(dppp)], [(ppy)₂Ir(6Tdppp)] and [(ppy)₂Ir(4Fdppp)] in CH₂Cl₂ at RT.

FIG. 4 depict emission spectra of Ir(III) complexes [(nazo)₂Ir(dppp)] and [(piq)₂Ir(dppp)] in CH₂Cl₂ at RT.

### DETAILED DESCRIPTION OF THE PREFERRED EMBODIMENTS

Reference will now be made in detail to the present embodiments of the invention, examples of which are illustrated in the accompanying drawings. Wherever possible, the same reference numbers are used in the drawings and the description to refer to the same or like parts.

The present invention provides a new class of luminescent iridium(III) complexes, luminescent material and organic electroluminescent device thereof, which comprise a formula [(ĈN)₂Ir(P̂O)]; for example, having the following structure:

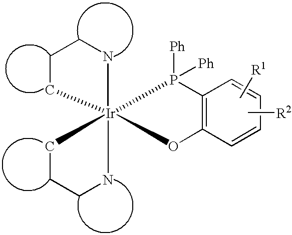

Moreover, synthesis of the iridium (III) complexes with formula [(ĈN)₂Ir(P̂O)] comprises the following procedures, see reaction scheme (I):

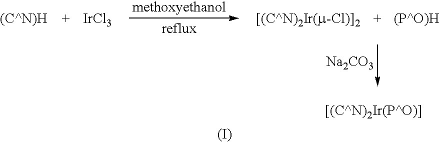

A luminescent material of iridium(III) complexes of the present invention comprises the new class of luminescent iridium(III) complexes with formula [(ĈN)₂Ir(P̂O)], while the luminescent material further comprises a host compound and a guest compound, wherein the guest compound comprises the new class of luminescent iridium(III) complexes with the formula [(ĈN)₂Ir(P̂O)].

An organic electroluminescent device of the present invention comprises at least an organic electroluminescent material layer with a emitting layer formed by a luminescent material comprising at least a new class of luminescent iridium(III) complexes comprising the formula [(ĈN)₂Ir(P̂O)]. The luminescent material further comprising a host compound and a guest compound, wherein the guest compound comprises the new class of luminescent iridium(III) complexes comprising at least the formula [(ĈN)₂Ir(P̂O)].

In one of the preferred embodiments, the (ĈN)H is a substituted cyclometalated ligand with structure indicated below:

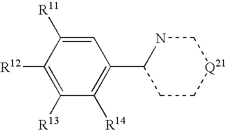

for which, R¹¹, R¹², R¹³ and R¹⁴ represent a hydrogen atom, saturated and unsaturated alkyl substituent, aryl substituent, fluorine atom, fluorinated alkyl substituent or other electron-withdrawing substituent, while Q²¹ represents an atomic group forming a nitrogen-containing heterocyclic ring. In the reaction (I), the chloride bridged dimers [(ĈN)₂Ir(μ-Cl)]₂, where (ĈN)H stands for 2-(4′,6′-difluorophenyl)pyridine, 2-phenylpyridine, 1-phenylisoquinoline or 4-phenylquinazoline, were synthesized from the direct reaction employing 4.0 equiv. of the cyclometalated (ĈN)H ligand mixed with IrCl₃ hydrate in refluxing methoxyethanol solvent. Subsequent treatment of [(ĈN)₂Ir(μ-Cl)]₂ with stoichiometric amount of (P̂O)H ligand and Na₂CO₃ as proton scavenger gave isolation of the heteroleptic Ir(III) complexes [(ĈN)₂Ir(P̂O)].

In one of the preferred embodiments, the (P̂O)H can be the 2-(diphenylphosphino)phenol or its alkyl, aryl, fluoro or CF₃ substituted derivatives and comprise the following structure:

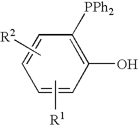

In one of the preferred embodiments, a synthesis of the (P̂O)H comprises at least the following reaction (II):

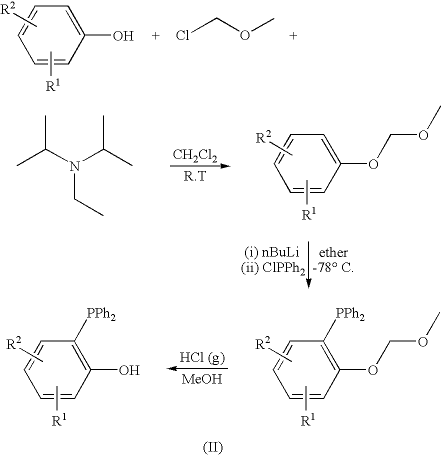

wherein R¹ is —H, alkyl, aryl, —F or —CF₃ and R² is —H alkyl, aryl, —F or —CF₃ and PPh₂ is diphenylphosphino group or its functionalized derivatives with alkyl, fluorine atom, or fluorinated alkyl substituent at the phenyl sites.

As depicted in the above synthesis, the required 2-(diphenylphosphino)phenol and its fluoro or CF₃ substituted derivatives, denoted as (P̂O)H, were obtained in multi-steps synthetic sequences involving the first preparation of 1-(methoxymethoxy)benzene (or its fluoro or CF₃ substituted derivatives) using the phenol reagents and chloromethyl methyl ether, followed by direct lithiation of 1-(methoxymethoxy)benzene with n-BuLi, addition of chlorodiphenylphosphine and the deprotection of phenol functional group using anhydrous HCl in methanol.

In one of the preferred embodiments, the formula [(ĈN)₂Ir(P̂O)] comprises the complex of [(dfppy)₂Ir(dppp)] of the following structure:

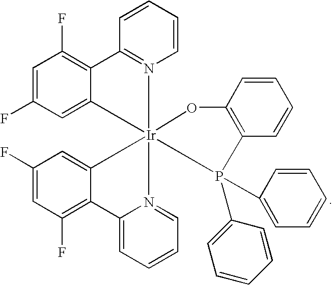

In one of the preferred embodiments, the formula [(ĈN)₂Ir(P̂O)] comprises the complex of [(dfppy)₂Ir(4Tdppp)] of the following structure:

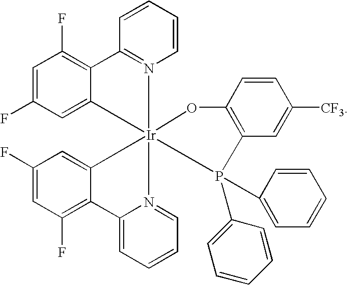

In one of the preferred embodiments, the formula [(ĈN)₂Ir(P̂O)] comprises the complex of [(dfppy)₂Ir(6Tdppp)] of the following structure:

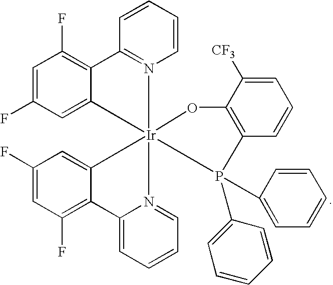

In one of the preferred embodiments, the formula [(ĈN)₂Ir(P̂O)] comprises the complex of [(dfppy)₂Ir(4Fdppp)] of the following structure:

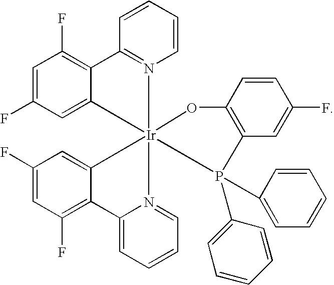

In one of the preferred embodiments, the formula [(ĈN)₂Ir(P̂O)] comprises the complex of [(ppy)₂Ir(dppp)] of the following structure:

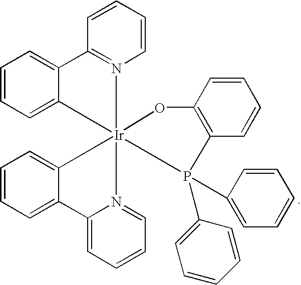

In one of the preferred embodiments, the formula [(ĈN)₂Ir(P̂O)] comprises the complex of [(ppy)₂Ir(6Tdppp)] of the following structure:

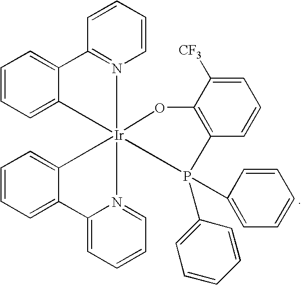

In one of the preferred embodiments, the formula [(ĈN)₂Ir(P̂O)] comprises the complex of [(ppy)₂Ir(4Fdppp)] of the following structure:

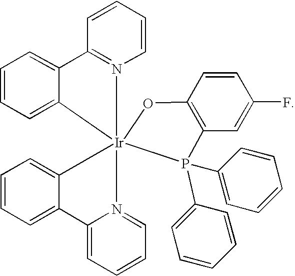

In one of the preferred embodiments, the formula [(ĈN)₂Ir(P̂O)] comprises the complex of [(nazo)₂Ir(dppp)] of the following structure:

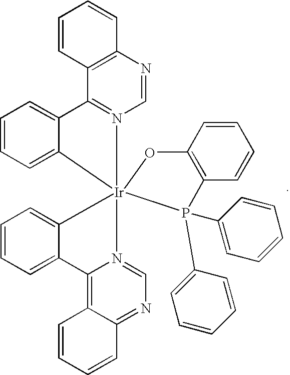

In one of the preferred embodiments, the formula [(ĈN)₂Ir(P̂O)] comprises the complex of [(piq)₂Ir(dppp)] of the following structure:

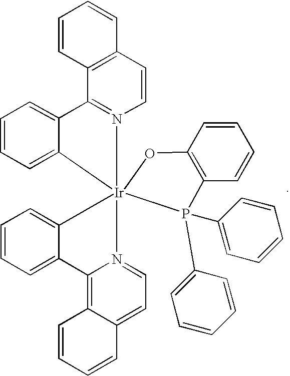

In the above complexes of the formula [(ĈN)₂Ir(P̂O)], their photophysical properties are somewhat analogous to other iridium metal complexes that possess the similar cyclometalated ligands, albeit with notable distinction at their third, ancillary ligand site. In addition, all the (P̂O) substituted complexes are highly soluble in chlorinated organic solvents and showing negligible decomposition in solution within a period of 24 hours.

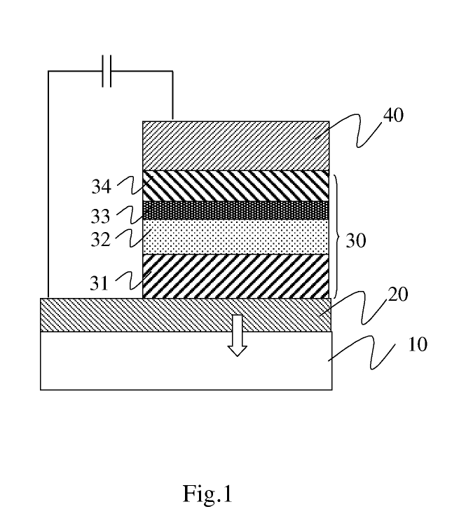

FIG. 1 is a schematic diagram illustrating a structure of an organic electroluminescent device according to one of the preferred embodiments of the present invention. As shown in FIG. 1, an anode 20, an organic electroluminescent material layer 30 and a cathode 40 are sequentially plated on a flat substrate 10. The organic electroluminescent material layer 30 comprises a hole-transport layer 31, the emitting layer 32, a hole-blocking layer 33, and an electron-transport layer 34. More particularly, the emitting layer 32 is formed with the luminescent material, comprising the guest compound of the new class of luminescent iridium(III) complexes. In this device, the direction of light is shown as the arrow.

The present invention provides a systematic design, synthesis and characterization of heteroleptic iridium (III) complexes possessing the 2-(diphenylphosphino)phenolate as the third, ancillary ligand. The high rigidity of the ligand framework as well as the strong σ-donating and concomitant π-accepting strength of the unique diphenylphosphino fragment would significantly reduce the vibration induced nonradiative decay transition and the unwanted thermal quenching by population to the upper-lying metal centered dd excited state, respectively. On the other hand, the energies of ππ* or MLCT manifolds, i.e. the energy gap between the ground and the emitting excited states, can be fine-tuned by adding at least one electronegative fluorine atom or even the CF₃ substituent at the phenolate fragment, giving emitters with higher volatility as well as both modified electrochemical and emission characteristics.

Moreover, with respect to the chemical stabilities of these heteroleptic complexes, most of the L̂X ligand mentioned in previous technologies belong to the so-called weak field ligands, as they possess the O-donor or N-donor fragments. As the result, the chemical stabilities as well as the relatively energy gap for the metal centered dd transition could not be as strong as those involving the higher field-strength ligands, such as the cyclometalated ĈN ligand as observed in the homoleptic complexes [Ir(ĈN)₃] or even chelating ligand with at least one phosphine substituent.

The present invention provides the synthetic method of new class of luminescent iridium(III) complexes for simple synthesizing the iridium(III) complexes with 2-(diphenylphosphino)phenolate as the ancillary chelate.

The present invention provides a new class of luminescent iridium(III) complexes, which have various derivatives with different substituents, for fabricating diversified luminescent materials and organic electroluminescent devices.

The present invention provides a new class of luminescent iridium(III) complexes, which can be used as the red, blue or green-emitting dopants. These luminescent materials can be applied in fabrication of the light-emitting layer of organic electroluminescent devices for high efficient phosphorescence.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

### EXPERIMENTS

Without intending to limit it in any manner, the present invention will be further illustrated by the following examples.

### Example 1

### General Methods

Reactions were performed under nitrogen. Solvents were distilled from appropriate drying agent prior to use. Commercially available reagents were used without further purification unless otherwise stated. Reactions were monitored by TLC with Merck pre-coated glass plates (0.20 mm with fluorescent indicator UV₂₅₄). Compounds were visualized with UV light irradiation at 254 nm and 365 nm. Flash column chromatography was carried out using silica gel from Merck (230-400 mesh). Mass spectra were obtained on a JEOL SX-102A instrument operating in electron impact (EI) mode or fast atom bombardment (FAB) mode. ¹H and ¹³C NMR spectra were recorded on Varian Mercury-400 or INOVA-500 instruments; chemical shifts are quoted with respect to the internal standard tetramethylsilane for ¹H and ¹³C NMR data.

### Example 2

### Synthesis of [(dfppy)₂Ir(dppp)] and Derivatives

A 25 mL flask was charged with [(dfppy)₂Ir(μ-Cl)]₂ (122 mg, 0.1 mmol), 2-(diphenylphosphino)phenol (dpppH, 61 mg, 0.22 mmol), Na₂CO₃ (106 mg, 1.0 mmol) and 2-methoxyethanol (10 mL). After the mixture was heated at 120° C. for 1.5 h, the reaction was quenched by addition of excess water (15 mL). The precipitate was filtered and washed with anhydrous ethanol and diethyl ether in sequence. The product was purified by silica gel column chromatography using EA/hexane=1:1 as eluent, followed by recrystallization from a mixture of CH₂Cl₂ and hexane at RT, giving a pale yellow crystalline solid [(dfppy)₂Ir(dppp)] (53 mg, 0.06 mmol) in 56% yield. The related Ir(III) complexes [(dfppy)₂Ir(4Tdppp)], [(dfppy)₂Ir(6Tdppp)], and [(dfppy)₂Ir(4Fdppp)] were prepared using similar procedures; yield 46% ˜56%.

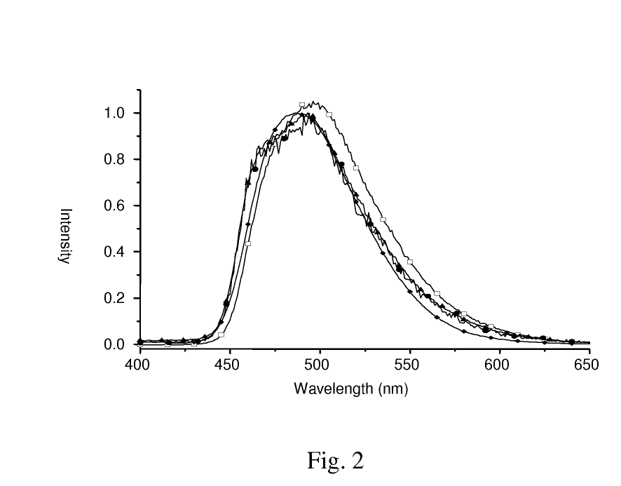

FIG. 2 depicts emission spectra of Ir(III) complexes [(dfppy)₂Ir(dppp)], [(dfppy)₂Ir(4Tdppp)], [(dfppy)₂Ir(6Tdppp)] and [(dfppy)₂Ir(4Fdppp)] in CH₂Cl₂ at RT. In FIG. 2, symbol (-□-) represents emission spectrum of [(dfppy)₂Ir(dppp)], symbol (--) represents emission spectrum of [(dfppy)₂Ir(4Tdppp)], symbol (-▴-) represents emission spectrum of [(dfppy)₂Ir(6Tdppp)] and symbol (-♦-)represents emission spectrum of [(dfppy)₂Ir(4Fdppp)] in CH₂Cl₂ at RT (298K).

Spectra data for [(dfppy)₂Ir(dppp)]. MS (FAB, ¹⁹²Ir): observed m/z [assignment]: 850 [M⁺], 660 [M⁺-dfppy], 573 [M⁺-dpp]. ¹H NMR (400 MHz, CDCl₃, 294K): δ 8.38 (dd, J=5.8, 0.6 Hz, 1H), 8.23 (dd, J=8.4, 2.4 Hz, 1H), 8.06 (d, J=6.0 Hz, 1H), 7.74 (t, J=8.2 Hz, 2H), 7.60 (t, J=7.4 Hz, 2H), 7.46-7.36 (m, 4H), 7.34 (t, J=7.8 Hz, 1H), 7.24 (t, J=8.4 Hz, 1H), 7.07 (dd, J=8.4, 6.0 Hz, 1H), 7.02 (t, J=7.6 Hz, 1H), 6.86˜6.82 (m, 3H), 6.65 (t, J=7.2 Hz, 1H), 6.56 (d, J=7.2 Hz, 1H), 6.54 (d, J=8.4 Hz, 1H), 6.45˜6.33 (m, 3H), 6.04 (dd, J=8.4, 2.2 Hz, 1H), 5.48 (ddd, J=8.2, 5.6, 2.6 Hz, 1H). ¹⁹F{¹H} NMR (470 MHz, CDCl₃, 294K): δ −108.22 (s, 1F), −108.77 (s, 1F), −109.89 (s, 1F), −111.33 (s, 1F). ³¹P{¹H} NMR (202 MHz, CDCl₃, 294K): δ 12.56 (s, 1P). Anal. Calcd for C₄₀H₂₆F₄IrN₂OP: N, 3.30; C, 56.53; H, 3.08. Found: N, 3.63; C, 56.15; H, 3.55.

Spectra data for [(dfppy)₂Ir(4Tdppp)]. MS (FAB, ¹⁹²Ir): observed m/z [assignment]: 918 [M⁺], 573 [M⁺−4Tdppp]. ¹H NMR (400 MHz, CDCl₃, 294K): δ 8.28 (dd, J=5.6, 0.6 Hz, 1H), 8.25 (dd, J=8.4, 2.4 Hz, 1H), 8.08 (d, J=6.0 Hz, 1H) 7.71˜7.62 (m, 5H), 7.49˜7.35 (m, 5H), 7.05 (t, J=7.4 Hz, 2H), 6.87˜6.83 (m, 3H), 6.53˜6.48 (m, 3H), 6.44˜6.35 (m, 2H), 6.04 (dd, J=8.6, 2.5 Hz, 1H), 5.47 (ddd, J=8.0, 5.6, 2.4 Hz, 1H). ¹⁹F{¹H} NMR (470 MHz, CDCl₃, 294K): δ −60.28 (s, 3F), −107.78 (s, 1F), −109.31 (s, 1F), −109.56 (s, 1F), −111.02 (s, 1F). ³¹P{¹H} NMR (202 MHz, CDCl₃, 294K): δ 11.79 (s, 1P). Anal. Calcd for C₄₁H₂₅F₇IrN₂OP: N, 3.05; C, 53.65; H, 2.75. Found: N, 3.35; C, 53.73; H, 3.20.

Spectra data for [(dfppy)₂Ir(6Tdppp)]. MS (FAB, ¹⁹²Ir): observed m/z [assignment]: 918 [M⁺], 573 [M⁺−6Tdppp]. ¹H NMR (400 MHz, CDCl₃, 294K): δ 8.26˜8.22 (m, 2H), 8.10 (d, J=6.0 Hz, 1H), 7.69˜7.65 (m, 3H), 7.62 (t, J=8.0 Hz, 1H), 7.53 (t, J=8.0 Hz, 1H), 7.48˜7.38 (m, 5H), 7.04 (t, J=7.4 Hz, 1H), 6.85 (t, J=7.4 Hz, 1H), 6.84 (t, J=7.8 Hz, 1H), 6.78 (t, J=6.6 Hz, 1H), 6.58 (t, J=7.6 Hz, 1H), 6.54 (d, J=8.0 Hz, 1H), 6.51 (d, J=8.0 Hz, 1H), 6.46 (t, J=7.4 Hz, 1H), 6.43˜6.36 (m, 2H), 6.16 (dd, J=8.8, 2.5 Hz, 1H), 5.42 (dd, J=8.4, 5.6 Hz, 1H). ¹⁹F NMR (470 MHz, CDCl₃, 294K): δ −63.64 (s, 3F), −108.38 (s, 1F), −108.77 (s, 1F), −110.16 (s, 1F), −111.22 (s, 1F). ³¹P{¹H} NMR (202 MHz, CDCl₃, 294K): δ 11.46 (s, 1P). Anal. Calcd for C₄₁H₂₅F₇IrN₂OP: N, 3.05; C, 53.65; H, 2.75. Found: N, 3.34; C, 53.31; H, 3.05.

Spectra data for [(dfppy)₂Ir(4Fdppp)]. MS (FAB, ¹⁹²Ir): observed m/z [assignment]: 868 [M⁺], 573 [M⁺−4Fdppp]. ¹H NMR (400 MHz, CDCl₃, 294K): δ 8.37 (d, J=5.8 Hz, 1H), 8.23 (d, J=6.8 Hz, 1H), 8.11 (d, J=5.6 Hz, 1H), 7.72 (d, J=6.4 Hz, 1H), 7.70 (d, J=8.4 Hz, 1H), 7.63 (t, J=8.4 Hz, 2H), 7.45˜7.24 (m, 4H), 7.08˜6.96 (m, 4H), 6.86˜6.82 (m, 3H), 6.55˜6.47 (m, 3H), 6.42˜6.34 (m, 2H), 6.05 (d, J=8.8 Hz, 1H), 5.46 (m, 1H). ¹⁹F{¹H}NMR (470 MHz, CDCl₃, 294K): δ −107.99 (s, 1F), −108.56 (s, 1F), −109.76 (s, 1F), −110.17 (s, 1F), −131.27 (s, 1F). ³¹P{¹H} NMR (202 MHz, CDCl₃, 294K): δ 12.63 (s, 1P). Anal. Calcd for C₄₀H₂₅F₅IrN₂OP: N, 3.23; C, 55.36; H, 2.90. Found: N, 3.28; C, 54.74; H, 3.13.

### Example 3

### Synthesis of [(ppy)₂Ir(dppp)] and Derivatives

A 25 mL flask was charged with [(ppy)₂Ir(μ-Cl)]₂ (107 mg, 0.1 mmol), 2-(diphenylphosphino)phenol (dpppH, 61 mg, 0.22 mmol), Na₂CO₃ (106 mg, 1.0 mmol) and 2-methoxyethanol (10 mL). The mixture was allowed to heat at 120° C. for 1.5 h. After the solution was cooled to RT, the reaction was quenched by addition of deionized water (15 mL). The precipitate was filtered and washed with anhydrous ethanol and diethyl ether in sequence. Purification was carried out by silica gel column chromatography using pure EA as eluent, followed by recrystallization from a mixture of CH₂Cl₂ and hexane at RT, giving a pale yellow crystalline solid [(ppy)₂Ir(dppp)] (80 mg, 0.05 mmol) in 51% yield. Synthesis of related derivative complexes [(ppy)₂Ir(6Tdppp)], and [(ppy)₂Ir(4Fdppp)] followed similar experimental procedures; yield 55˜58%.

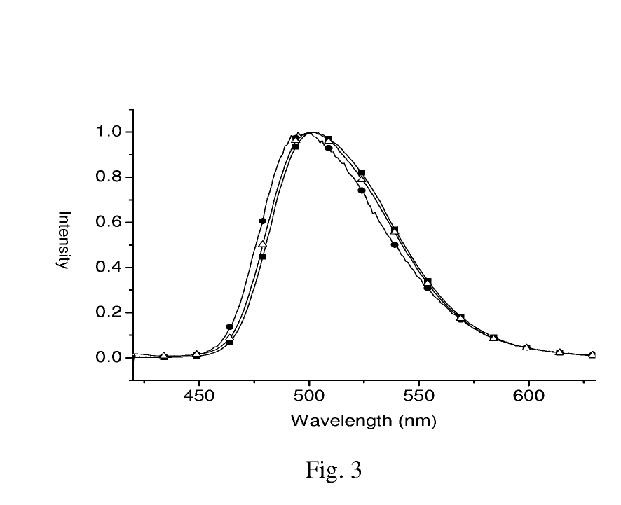

FIG. 3 depicts emission spectra of Ir(III) complexes [(ppy)₂Ir(dppp)], [(ppy)₂Ir(6Tdppp)] and [(ppy)₂Ir(4Fdppp)] in CH₂Cl₂ at RT. In FIG. 3, symbol (-▪-) represents emission spectrum of [(ppy)₂Ir(dppp)], symbol (--) represents emission spectrum of [(ppy)₂Ir(6Tdppp)] and symbol (-Δ-) represents emission spectrum of [(ppy)₂Ir(4Fdppp)] in CH₂Cl₂ at RT.

Spectra data for [(ppy)₂Ir(dppp)]. MS (FAB, ¹⁹²Ir): observed m/z [assignment]: 778 [M₊], 624 [M⁺−ppy], 501 [M⁺−4Fdppp]. ¹H NMR (400 MHz, CDCl₃, 294K): δ 8.37 (d, J=5.2 Hz, 1H), 8.06 (d, J=5.6 Hz, 1H), 7.81˜7.74 (m, 3H), 7.59 7.53 (m, 2H), 7.43 (td, J=7.8, 1.6 Hz, 1H), 7.39˜7.30 (m, 4H), 7.27 (d, J=7.2 Hz, 1H), 7.24−7.19 (m, 3H), 7.03 (dd, J=7.6, 6.0 Hz, 1H), 6.97 (t, J=6.0 Hz, 1H), 6.88˜6.82 (m, 3H), 6.82˜6.76 (m, 4H), 6.62 (t, J=6.4 Hz, 2H), 6.53 (t, J=8.4 Hz, 2H), 6.42 (t, J=6.0 Hz, 1H), 6.07 (dd, J=6.8, 4.4 Hz, 1H). ³¹P{¹H} NMR (202 MHz, CDCl₃, 294K): δ 12.30 (s, 1P). Anal. Calcd for C₄₀H₃₀IrN₂OP: N, 3.60; C, 61.76; H, 3.89. Found: N, 3.68; C, 61.45; H, 4.24.

Spectra data for [(ppy)₂Ir(6Tdppp)]: MS (FAB, ¹⁹²,r): observed m/z [assignment]: 846 [M⁺], 692 [M⁺−ppy], 501 [M⁺−6Tdppp]. ¹H NMR (400 MHz, CDCl₃, 294K): δ 8.28 (d, J=6.0 Hz, 1H), 8.10 (d, J=5.6 Hz, 1H), 7.77 (d, J=8.0 Hz, 1H), 7.73 (t, 8.4 Hz, 2H), 7.57 (d, J=7.6 Hz, 1H), 7.53 (t, J=7.8 Hz, 2H), 7.45 (d, J=7.2 Hz, 1H), 7.41˜7.34 (m, 4H), 7.29 (d, J=4.8 Hz, 2H), 6.98 (t, J=7.4 Hz, 1H), 6.90˜6.69 (m, 8H), 6.56˜6.48 (m, 3H), 6.42 (t, J=6.0 Hz, 1H), 6.01 (dd, J=7.6, 4.4 Hz, 1H), ¹⁹F{¹H} NMR (470 MHz, CDCl₃, 294K): δ−63.41 (s, 3F). ³¹P{¹H} NMR (202 MHz, CDCl₃, 294K): δ 11.17 (s, 1P). Anal. Calcd for C₄₁H₂₉F₃IrN₂OP: N, 3.31; C, 58.22; H, 3.46. Found: N, 3.33; C, 53.97.45; H, 3.60.

Spectra data for [(ppy)₂Ir(4Fdppp)]. MS (FAB, ¹⁹²Ir): observed m/z [assignment]: 796 [M⁺], 642 [M⁺−ppy], 501 [M⁺−4Fdppp]. ¹H NMR (400 MHz, CDCl₃, 294K): δ 8.36 (d, J=6.6 Hz, 1H), 8.12 (d, J=6.6 Hz, 1H), 7.81 (d, J=8.0 Hz, 1H), 7.71 (t, J=8.6 Hz, 2H), 7.57 (t, J=7.8 Hz, 2H), 7.41˜7.31 (m, 4H), 7.29˜7.25 (t, J=7.6 Hz, 2H), 7.06 (t, J=8.0 Hz, 1H), 7.02˜6.73 (m, 10H), 6.62 (d, J=7.2 Hz, 1H), 6.53˜6.45 (m, 3H), 6.05 (dd, J=7.4, 4.0 Hz, 1H). ¹⁹F{¹H} NMR (470 MHz, CDCl₃, 294K): δ−132.03 (s, 3F). ³¹P{¹H} NMR (202 MHz, CDCl₃, 294K): δ 12.37 (s, 1P). Anal. Calcd for C₄₀H₂₉FIrN₂OP: N, 3.52; C, 60.37; H, 3.67. Found: N, 3.39; C, 56.36; H, 4.30

### Example 4

### Synthesis of [(nazo)₂Ir(dppp)]

A 25 mL flask was charged with [(nazo)₂Ir(μ-Cl]₂ (64 mg, 0.05 mmol), 2-(diphenylphosphino)phenol (dpppH, 31 mg, 0.11 mmol), Na₂CO₃ (53 mg, 0.5 mmol) and 2-methoxyethanol (10 mL). The mixture was heated at 120° C. for 2 h. After the solution was cooled to RT, the reaction was quenched with deionized water (15 mL). The precipitate was filtered and rinsed with anhydrous ethanol and diethyl ether in sequence. The solid was further purified by silica gel column chromatography using EA/hexane=1:1 as eluent, followed by recrystallization from a mixture of CH₂Cl₂ and methanol at RT, giving a dark red crystalline solid [(nazo)₂Ir(dppp)] (57 mg, 0.06 mmol) in 65% yield.

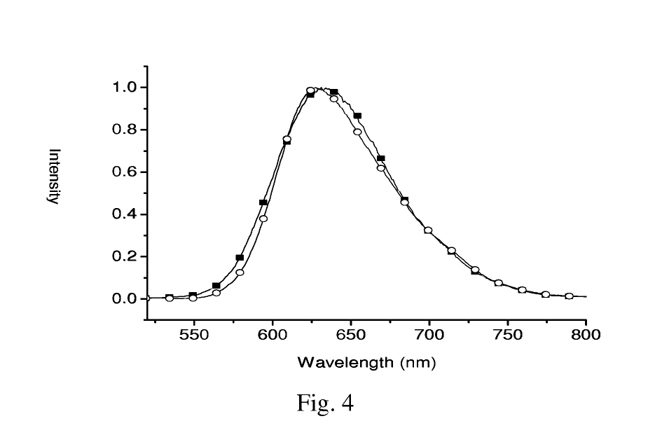

FIG. 4 depicts emission spectra of Ir(III) complexes [(nazo)₂Ir(dppp)] and [(piq)₂Ir(dppp)] in CH₂Cl₂ (298K). In FIG. 4 symbol (-▪-) represents emission spectrum of [(nazo)₂Ir(dppp)] and symbol (-o-) represents emission spectrum of [(piq)₂Ir(dppp)] in CH₂Cl₂ at RT.

Spectra data for [(nazo)₂Ir(dppp)]. MS (FAB, ¹⁹²Ir): observed m/z [assignment]: 880 [M⁺], 675 [M⁺−nazo], 603 [M⁺−dppp]. ¹H NMR (400 MHz, CDCl₃, 294K): δ 9.21 (s, 1H), 8.80 (d, J=7.2 Hz, 1H), 8.65 (s, 1H), 8.44 (d, J=8.4 Hz, 1H), 8.28 (d, J=8.4 Hz, 1H), 8.17 (d, J=8.0 Hz, 1H), 7.93 (t, J=7.4 Hz, 2H), 7.84 (t, J=7.6 Hz, 1H), 7.78˜7.68 (m, 4H), 7.59 (t, J=7.8 Hz, 1H), 7.44˜7.38 (m, 4H), 7.16 (t, J=8.8 Hz, 1H), 7.03˜6.91 (m, 3H), 6.90˜6.85 (m, 2H), 6.81 (t, J=7.6 Hz, 1H), 6.60 (t, J=7.4 Hz, 1H), 6.49˜6.42 (m, 5H), 6.36 (dd, J=8.4, 4.0 Hz, 1H). ³¹P{¹H} NMR (202 MHz, CDCl₃, 294K): δ 12.30 (s, 1P). Anal. Calcd for C₄₆H₃₂IrN₄OP: N, 6.37; C, 62.79; H, 3.67. Found: N, 6.57; C, 61.52; H, 3.93.

### Example 5

### Synthesis of [(piq)₂Ir(dppp)]

A 25 flask was charged with [(piq)₂Ir(μ-Cl)]₂ (64 mg, 0.05 mmol), 2-(diphenylphosphino)phenol (dpppH, 31 mg, 0.11 mmol), Na₂CO₃ (53 mg, 0.5 mmol), and 2-methoxyethanol (10 mL). The reaction mixture was heated at 120° C. for 10 min then allowed to cool to RT. After then, excess water was added to qunch the reaction, the precipitate was filtered and washed by anhydrous ethanol and diethyl ether in sequence. The resulting solid was further purified by silica gel column chromatography using pure EA as eluent, followed by recrystallization from a mixture of CH₂Cl₂ and methanol at RT, giving red crystalline solid [(piq)₂Ir(dppp)] (27 mg, 0.03 mmol) in 31% yield.

Spectra data for [(piq)₂Ir(dppp)]. MS (FAB, ¹⁹²Ir): observed m/z [assignment]: 878 [M⁺], 601 [M⁺-dpp]. ¹H NMR (500 MHz, CD₂Cl₂, 294K): δ 8.88 (d, J=8.0 Hz, 1H), 8.55 (d, J=8.0 Hz, 1H), 8.37 (d, J=6.5 Hz, 1H), 8.17 (d, J=8.5 Hz, 1H), 8.10 (d, J=8.5 Hz, 1H), 7.99 (d, J=6.5 Hz, 1H), 7.76 (t, J=8.3 Hz, 3H), 7.71˜7.66 (m, 3H), 7.59˜7.55 (m, 2H), 7.45 (t, J=7.3, 1H), 7.42 (t, J=6.8 Hz, 1H), 7.35 (t, J=8.0 Hz, 2H), 7.20 (t, J=7.0 Hz, 1H), 7.17 (d, J=6.5 Hz, 1H), 7.01 (t, J=8.0 Hz, 1H), 6.97 (t, J=8.0 Hz, 1H), 6.91 (t, J=7.0 Hz, 1H), 6.81 (d, J=7.0 Hz, 1H), 6.80 (d, J=7.0 Hz, 1H), 6.76 (t, J=7.8 Hz, 1H), 6.65 (d, J=8.0 Hz, 1H), 6.60 (t, J=7.3 Hz, 1H), 6.48˜6.45 (m, 4H), 6.39˜6.37 (m, 2H). ³¹P{¹H} NMR (202 MHz, CD₂Cl₂, 294K): δ 13.31 (s, 1P). Anal. Calcd for C₄₈H₃₄IrN₂OP: N, 3.19; C, 65.66; H, 3.90. Found: N, 3.06; C, 64.33; H, 4.12.

### Example 6

### Measurement of Photophysical Data

Steady-state absorption and emission spectra were recorded by a Hitachi (U-3310) spectrophotometer and an Edinburgh (FS920) fluorimeter, respectively. Both wavelength-dependent excitation and emission response of the fluorimeter have been calibrated. A configuration of front-face excitation was used to measure the emission of the solid sample, in which the cell was made by assembling two edge-polished quartz plates with various Teflon spacers. A combination of appropriate filters was used to avoid the interference from the scattering light.

Lifetime studies were performed by an Edinburgh FL 900 photon-counting system with a hydrogen-filled/or a nitrogen lamp as the excitation source. Data were analyzed using the nonlinear least squares procedure in combination with an iterative convolution method. The emission decays were analyzed by the sum of exponential functions, which allows partial removal of the instrument time broadening and consequently renders a temporal resolution of ˜200 ps. The combined spectroscopic data are listed in Table 1, while their emission spectra are depicted in FIGS. 2, 3 and 4, respectively.

TABLE 1
The photophysical data of the iridium(III) complexes
recorded in degassed CH₂Cl₂ solution.

| Entries | abs. λₘₐₓ/nm | em. λₘₐₓ/nm |
|---|---|---|
| [(dfppy)₂Ir(dppp)] | 253, 297, 354 | 496 |
| [(dfppy)₂Ir(4Tdppp)] | 253, 297, 344 | 475, 494 |
| [(dfppy)₂Ir(6Tdppp)] | 257, 292, 352 | 473, 492 |
| [(dfppy)₂Ir(4Fdppp)] | 259, 298, 363 | 487 |
| [(ppy)₂Ir(dppp)] | 257, 296, 353 | 502 |
| [(ppy)₂Ir(6Tdppp)] | 255, 300, 370 | 498 |
| [(ppy)₂Ir(4Fdppp)] | 258, 300, 357 | 500 |
| [(nazo)₂Ir(dppp)] | 345, 465 | 634 |
| [(piq)₂Ir(dppp)] | 334, 424, 461 | 629 |

What is claimed is:

1. A class of luminescent iridium(III) complexes with 2-(diphenylphosphino)phenolate ligand, comprising at least a formula [(ĈN)₂Ir(P̂O)],
wherein a synthesis of the formula [(ĈN)₂Ir(P̂O)] comprises at least the following reaction (I):

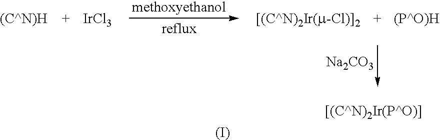

2. The class of luminescent iridium(III) complexes according to claim 1, wherein the formula [(ĈN)₂Ir(P̂O)] comprises the following structure:

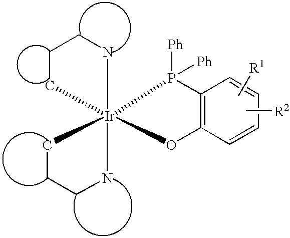

3. The class of luminescent iridium(III) complexes according to claim 1, wherein the (P̂O)H is 2-(diphenylphosphino)phenol or its alkyl, aryl, fluoro or CF₃ substituted derivatives and comprises the following structure:

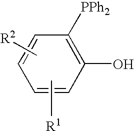

4. The class of luminescent iridium(III) complexes according to claim 3, wherein a synthesis of the (P̂O)H comprises at least the following reaction (II): 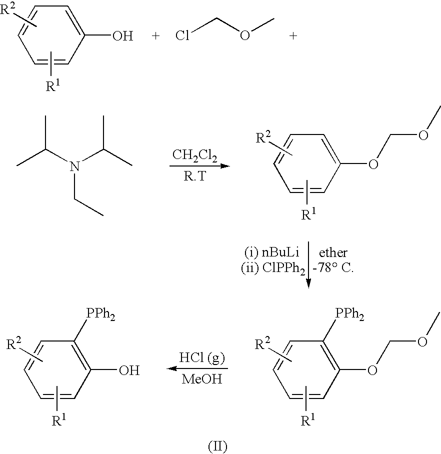
wherein R¹ is —H, alkyl, aryl, —F or —CF₃ and R² is —H, alkyl, aryl, —F or —CF₃, and PPh₂ is diphenylphosphino group or its functionalized derivatives with alkyl, fluorine, or fluorinated alkyl substituent at the phenyl sites.

5. The class of luminescent iridium(III) complexes according to claim 1, wherein the (ĈN)H is a substituted cyclometalated ligand with structure indicated below: 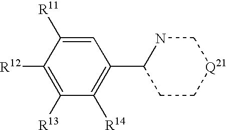
for which, R¹¹, R¹², R¹³ and R¹⁴ represent a hydrogen atom, saturated and unsaturated alkyl substituent, aryl substituent, fluorine atom, fluorinated alkyl substituent or other electron-withdrawing substituent, while Q²¹ represents an atomic group forming a nitrogen-containing heterocyclic ring.

6. The class of luminescent iridium(III) complexes according to claim 5, wherein the (ĈN)H is 2-(4′,6′-difluorophenyl)pyridine, 2-phenylpyridine, 1-phenylisoquinoline or 4-phenylquinazoline.

7. The class of luminescent iridium(III) complexes according to claim 1, wherein the formula [(ĈN)₂Ir(P̂O)] comprises the complex of [(dfppy)₂Ir(dppp)] of the following structure:

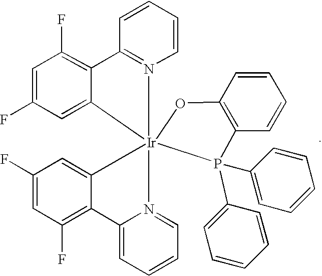

8. The class of luminescent iridium(III) complexes according to claim 1, wherein the formula [(ĈN)₂Ir(P̂O)] comprises the complex of [(dfppy)₂Ir(4Tdppp)] of the following structure:

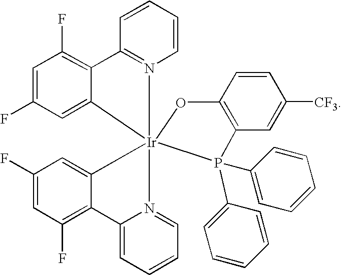

9. The class of luminescent iridium(III) complexes according to claim 1, wherein the formula [(ĈN)₂Ir(P̂O)] comprises the complex of [(dfppy)₂Ir(6Tdppp)] of the following structure:

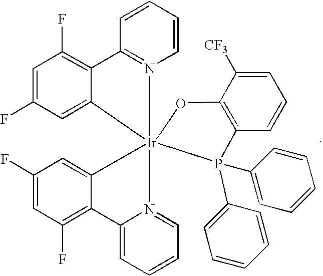

10. The class of luminescent iridium(III) complexes according to claim 1, wherein the formula [(ĈN)₂Ir(P̂O)] comprises the complex of [(dfppy)₂Ir(4Fdppp)] of the following structure:

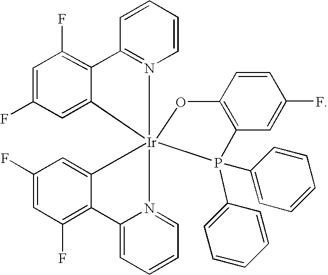

11. The class of luminescent iridium(III) complexes according to claim 1, wherein the formula [(ĈN)₂Ir(P̂O)] comprises the complex of [(ppy)₂Ir(dppp)] of the following structure:

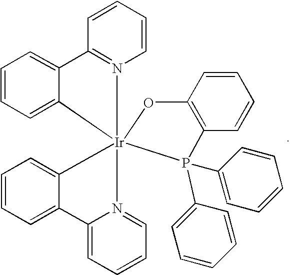

12. The class of luminescent iridium(III) complexes according to claim 1, wherein the formula [(ĈN)₂Ir(P̂O)] comprises the complex of [(ppy)₂Ir(6Tdppp)] of the following structure:

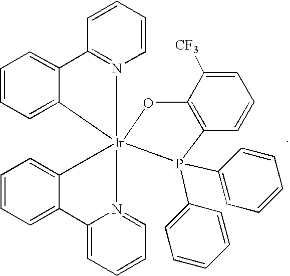

13. The class of luminescent iridium(III) complexes according to claim 1, wherein the formula [(ĈN)₂Ir(P̂O)] comprises the complex of [(ppy)₂Ir(4Fdppp)] of the following structure:

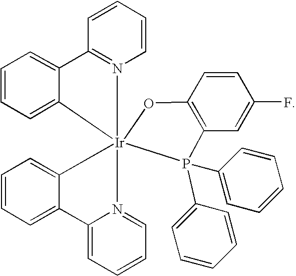

14. The class of luminescent iridium(III) complexes according to claim 1, wherein the formula [(ĈN)₂Ir(P̂O)] comprises the complex of [(nazo)₂Ir(dppp)] of the following structure:

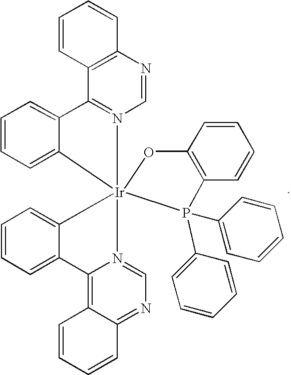

15. The class of luminescent iridium(III) complexes according to claim 1, wherein the formula [(ĈN)₂Ir(P̂O)] comprises the complex of [(piq)₂Ir(dppp)] of the following structure:

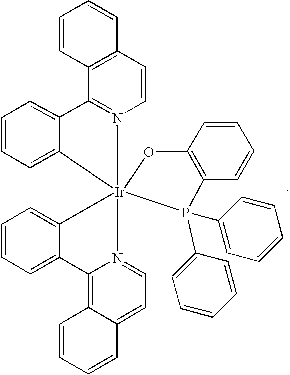

16. A luminescent material of iridium(III) complexes, comprising at least a class of luminescent iridium(III) complexes with the formula [(ĈN)₂Ir(P̂O)] according to claim 1.

17. The luminescent material according to claim 16, wherein the luminescent material further comprises a host compound and a guest compound and the guest compound comprises the class of luminescent iridium(III) complexes with the formula [(ĈN)₂Ir(P̂O)].

18. An organic electroluminescent device, comprising at least an organic electroluminescent material layer with a emitting layer formed by a luminescent material comprising at least a class of luminescent iridium(III) complexes with the formula [(ĈN)₂Ir(P̂O)] according to claim 1.

19. The organic electroluminescent device according to claim 18, wherein the luminescent material further comprises a host compound and a guest compound and the guest compound comprises the class of luminescent iridium(III) complexes with the formula [(ĈN)₂Ir(P̂O)].

20. The organic electroluminescent device according to claim 18, wherein the organic electroluminescent material layer comprises a hole-transport layer, the emitting layer, a hole-blocking layer and an electron-transport layer.
